(19) United States
(12) Patent Application Publication
(10) Pub. No.: US 2003/0086573 A1
(43) Pub. Date: May 8, 2003

(54) Method for reproducing sound signals and sound reproducing system

(76) Inventors: Daniel Willem Elisabeth Schobben, Eindhoven (NL); Ronaldus Maria Aarts, Eindhoven (NL)

Correspondence Address: U.S. Phillips Corporation, 580 White Plains Road, Tarrytown, NY, 10591, US

(21) Appl. No.: 10/261,891

(22) Filed: Sep. 30, 2002

(30) Foreign Application Priority Data
Oct. 3, 2001 (EP) 01203735.4

(51) Int. Cl. H04R 3/02; H04R 1/10

(52) U.S. Cl. 381/74; 381/73.1

(57) ABSTRACT

In a method for reproducing sound signals by means of headphones provided with microphones, unwanted sound signals from at least one external sound source are compensated by sound signals, simulating in anti-phase the sound signals from said at least one external sound source. The anti-phase sound signals being generated in the headphones in response to signals derived from audio input signals of the at least one external sound source in a first filter device which is controlled by the resulting microphone signals. Further, wanted sound signals are generated in the headphones in response to signals derived from further audio input signals in a second filter device with transfer functions substantially equal to the corresponding transfer functions of the first filter device.

The invention relates to a method for reproducing sound signals and to a sound reproducing system with headphones provided with microphones for applying this method.

When two or more people want to listen to different audio signals inside the same room, for example in case of a dual window television, at least one of them typically needs to wear headphones. In such a case, ideally, the headphones listener wants to receive the same sound quality as the person who listens to the loudspeakers of the television. This means that the contribution of the loudspeakers in the headphones should be cancelled and the wanted audio signals should be processed at an improved manner.

Therefore, in order to cancel the contribution of the unwanted signals from at least one external sound source, such as a loudspeaker, and to process the wanted audio signals in such way that the headphones listener receives sound signals of the same quality as the loudspeaker listener, in accordance with the invention, there is provided a method for reproducing sound signals by means of headphones with microphones wherein unwanted sound signals from at least one external sound source are compensated by sound signals, simulating in anti-phase the sound signals from said at least one external sound source, said anti-phase sound signals being generated in the headphones in response to signals derived from audio input signals of the at least one external sound source in a first filter device which is controlled by the resulting microphone signals, and wherein wanted sound signals are generated in the headphones in response to signals derived from further audio input signals in a second filter device with transfer functions substantially equal to the corresponding transfer functions of the first filter device.

So, shortly said, according to the invention, an unwanted signal or noise cancellation system for headphones is combined with a wanted sound signal simulation system for headphones. The latter sound signals are simulated in such a way that the sound seems to be emerged from the loudspeakers (virtual 3D-sound).

Unwanted signal or noise cancellation systems for headphones are known per se, for example from the international patent application WO 94/30029. In this document a noise cancellation system for canceling unknown low frequency and high frequency, rapidly changing noise is described wherein microphones, included in the headphones, pick up sound signals generated in the headphones. Based on signals from the microphones the unknown noise is estimated whereafter anti-noise signals are generated by means of a noise cancellation algorithm. These anti-noise signals, supplied to the headphones, reduce the noise. The disadvantage of this method is that all sound signals are suppressed to some extend. In the present invention this disadvantage can be avoided, while, because known unwanted sound signals are cancelled, in a preferred embodiment, no estimation of the unwanted sound signals (noise) is necessary, which simplifies the cancellation of the unwanted sound signals.

Further it may be noted that the international patent application WO 01/49066 shows a sound reproducing system for simulating sound signals which seem to come from at least one external sound source. However, that sound reproduction system does not contain means for canceling unwanted signals. The system in said international patent application is operable in the following two phases: In a first phase a filter device is adjusted in such a manner that by means of an audio input signal supplied to a filter device a signal is generated in the sound generating means which compensates the audio input signal. Then, in a second phase the at least one external sound source is made inoperative, so that the sound generating means provide for a sound reproduction which simulates the at least one external sound source. The first phase is introduced for measuring the transfer functions from external sound sources (loudspeakers) to the microphones in headphones inside a listener ears. The sound is than generated by passing the audio signals through the filter means, adjusted to these transfer functions, and reproducing the resulting sound through the headphones.

During initialization, the characteristics of the first and second filter device may be computed by means of a sound source simulation algorithm, which algorithm controls the characteristics such that signals derived from the microphone signals and applied to adjust the filter characteristics are minimized or become substantially zero.

In order to prevent that the wanted signals in the microphone signal disturb the adjustment of the filter devices, correction signals are applied to the microphone signals, which correction signals are derived from the wanted audio input signals in said second filter device.

In a preferred embodiment the audio input signals of the second filter device have the function of wanted input signals for sound reproducing and of masking signals for the microphone signals as well.

When a person wearing the headphones wants to listen for some time to real sound signals of the loudspeakers, the audio input signals of the second filter device are made substantially equal to the audio input signals of the external sound sources during that time. Another possibility therefore is to switch off the headphones.

The invention also relates to a sound reproducing system, for applying the method of any one of the preceding claims, comprising headphones with sound generating means and with microphones, and control means, the control means being provided with a first and a second filter device to control the sound signals generated by said sound generating means to simulate in anti-phase at least one external sound source in response to the same unwanted audio input signal as applied to said at least one external sound source and to simulate said at least one external sound source in response to an audio input signal resulting in the wanted sound signals respectively, with regulation means to regulate said first and second filter device such that the signals supplied by the microphones and fed to the control means are minimized or become substantially zero. Particularly the first and second filter device are substantially the same.

In order to prevent that the wanted signals in the microphone signals do not disturb the adjustment of the filter devices, the control means further comprise combination means and correction means to correct the microphone signals with a correction signal derived from said wanted audio input signals, the transfer function of the correction means being substantially the same as the transfer function of the sound generating means to the microphones.

It may be occur that there are more audio input channels for audio input signals of the second filter device than there are external sound sources or audio input channels for input signals of the first filter device. In that case it is possible that some of the filters of the filter devices may be present in the form of fixed tables stored in a memory in said filters.

The invention further relates to an algorithm, applied in the method described above, for processing the above first and second filter device.

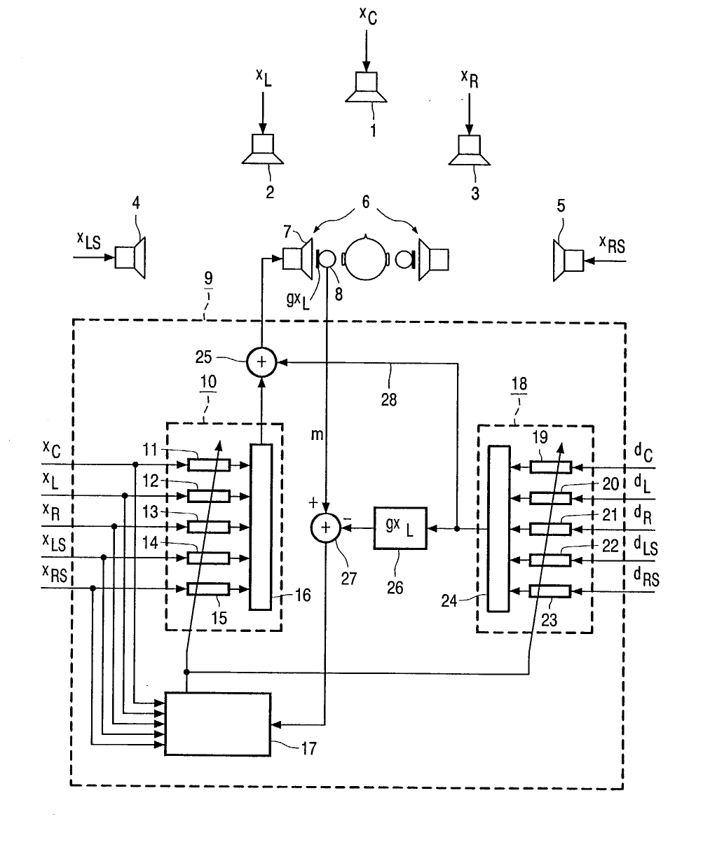

The invention will be apparent from and elucidated with reference to the example as described in the following and to the accompanying drawing, which shows in FIG. 1 schematically the sound reproducing system according to the invention.

In the example described there are five external sound sources in the form of loudspeakers 1-5, viz. for an audio center channel, left and right channels and surround channels. The audio input signals for these loudspeakers are indicated by respectively x_{C}, x_{L}, x_{R}, x_{Ls} and x_{Rs}, in general xᵢ. In the center of the FIGURE the head of a person is indicated; this person wears headphones 6 with sound generating means 7 and microphones 8. The processing according to the invention is only considered for the left ear of said person as the processing for the right ear is likewise. The microphone 8 supplies a microphone signal m in response to sound signals from the loudspeakers 1-5 and from the sound generating means 7. The input signal of the sound generating means 7 is supplied by control means 9. These control means comprise a first filter device 10 with filters 11-15 and combination means 16, and regulating means 17. The transfer function of the filters 11-15 is indicated by respectively h_{C,L}, h_{L,L}, h_{R,L}, h_{Ls,L} and h_{Rs,L}, in general h_{i,L,} The input signals of these filters are chosen for sake of simplicity to be the same as the input signals for the loudspeakers, viz. x_{C}, x_{L}, x_{R}, x_{Ls} and x_{RS} respectively. The filter device 10 supplies a signal σx_{i.hi,L} to the sound generating means 7. The “point” in this and following mathematical expressions means a multiplication in the frequency domain and a convolution in the time domain of the relevant signals and functions.

Apart from the signal supplied to the sound generating means 7 via the line 28 and the combination device 25, which will be discussed later on, the output signal of the sound generating means 7 established by the microphone 8 can be represented by gx_{L}.ρx_{i.hi,L} with gx_{L} the transfer function of the sound generating means 7 to the left microphone 8. When the transfer functions from the loudspeakers 1-5 to the left microphone 8 are represented by gx_{C,L}, gx_{L,L}, gx_{R,L}, gx_{Ls,L} and gx_{Rs,L}, in general gx_{i,L}, than the signal m from the left microphone 8 can be represented by:

m=ρx_{i.}[h_{i,L}g_{xL}+gx_{i,L}].

The filters characteristics are computed and regulated by means of a sound source simulation algorithm in the regulation means such that m is minimized, with m=0 in the ideal situation. This means that, after initialization, the signals from the sound generating means 7 are substantially equal to the signals from the loudspeakers, but in anti-phase, and thus that by means of said filters the sound signals from the loudspeakers are simulated.

When the filters 11-15 are adjusted, during initialization, in such a way that the microphone signal m is minimized the desired cancellation of the loudspeaker signals will be obtained. In that case the transfer functions of the filters 11-15: h_{i,L}=−gx_{i,L}/gx_{L}, are fixed.

When a person wearing the headphones moves or takes another location, the transfer functions from the loudspeakers 1-5 to the microphones change, so that the transfer functions of the filters 11-15 do not correspond any longer with forms with m minimized. Although in that case the initialization can be repeated for the new position, it may be an advantage when in the initialization phase for a number of head positions and/or neighboring positions a set of filter characteristics is established and stored in the regulation means 17. By means of a known head tracker, for example mounted on the headphones 6 the position of a head of the person wearing the headphones can be established and a specific set of filter characteristics can be selected therewith. In some cases, for example, when the tracking rate of the head tracker is not sufficient, it is of advantage that a filter with fixed filter characteristics is used or with filter characteristics which each time the head of the person wearing the headphones moves are gauged (updated) continuously.

In the above the cancellation part of the sound reproducing system for unwanted audio signals is described. In the following the sound simulation part thereof will be described.

In order to reproduce wanted audio signals d_{C}, d_{L}, d_{R}, d_{Ls}, d_{Rs}, in general dᵢ, in such a way that they seem to come from the loudspeakers 1-5 respectively, the control device 9 comprises a second filter device 18 with filters 19-23 and combination means 24. These filters 19-23 are substantially equal to the filters 11-15 and are hold equal to the latter filters by the regulation means 17. In a practical embodiment the same sound source simulation algorithm is used for the filters 11-15 and 19-23. The filter device 18 supplies a signal ρdᵢ.h_{i,L}, added to the ouput signal of the filter device 10 in a combination device 25, to the sound generating means 7. Now, the signal from the microphone can be represented by:

ρ{xᵢ.[h_{i,L}gx_{L}+gx_{i,L}]+dᵢ.h_{i,L}.gx_{L}}.

In order to maintain the same filter adjustment: h_{i,L}=−gx_{i,L}/gx_{L}, the microphone signal must be corrected. Therefore, the output signal of the filter device 18 is passed through a correction device 26 with a transfer function which is substantially the same as the transfer function from the sound generation means 7 to the microphone 8. The microphone signal is diminished with the output signal of the correction device 26, viz. ρdᵢ.h_{i,L}.gx_{L}, in the combination device 27.

In a preferred embodiment the first and second filter device are realized by one and the same filter device. In that case the input signal of this filter device will be xᵢ+dᵢ, while the function of the combination device 25 is integrated in said one and the same filter device, so that the output signal of the latter filter device supplied to the sound generating means 7 remains the same. However, this applies only in the case that the filter is not in the adapting mode.

By means of the above described sound reproducing system, after initialization, unwanted signals from the loudspeakers are suppressed, in a specific embodiment independent of the position where a person, wearing the headphones, is located in the room where the loudspeakers are arranged, while wanted signals are simulated as coming from the loudspeakers.

The input signals of the second filter device 18 can mask the residu signal, i.e. the microphone signal fed to the regulation means 17 remaining after non-ideal canceling. Without the signals dᵢ disturbing sounds will be heard which will not be heard when the signals dᵢ are applied. So, the audio signals di have the double function of desired input signals for sound reproduction and of masking signals for the microphone residu signal.

When a person wearing the headphones wants to listen for some time to the real sound signals of the loudspeakers 1-5, means may be provided wherein the signals dᵢ are made substantially equal to the signals xᵢ during that time. Another possibility therefore is the presence of switching means to switch off the headphones; in that case the headphones listener will only hear the sound of the loudspeakers.

The method and the embodiment described above may be realized by an algorithm, at least part of which may be in the form of a computer program capable of running on signal processing means in an audio apparatus or cooperating with an audio apparatus comprising the sound reproducing system according to the invention. In so far part of the FIGURE shows units to perform certain programmable functions, these units can be considered as subparts of the computer program.

It may be noted that, although not indicated in the FIGURE, corresponding control means are provided to suppress unwanted signals from the loudspeakers in the right ear and to simulate wanted sound signals coming from the loudspeakers.

The invention is not restricted to the described embodiment. Modifications are possible. For example, the number of external sound sources is irrelevant. When there are more audio input channels for audio input signals d, than there are loudspeakers or audio input channels for input signals xᵢ some of the filters may be present in the form of fixed tables stored in a memory.

The unwanted audio input signals applied to the first filter device need not to be equal to the unwanted audio input signals of the loudspeakers; it is sufficient when there is a relation between both audio input signals. Further, other unwanted signal or noise cancellation systems can be combined with the sound signal simulation system. Although in the described embodiment an unwanted signal cancellation system is described where the unwanted signals are known, unwanted signal cancellation systems may be used where the unwanted signals are unknown and must be estimated as for example in the international patent application WO 94/30029.

claims:

1. Method for reproducing sound signals by means of headphones provided with microphones wherein unwanted sound signals from at least one external sound source are compensated by sound signals, simulating in anti-phase the sound signals from said at least one external sound source, said anti-phase sound signals being generated in the headphones in response to signals derived from audio input signals of the at least one external sound source in a first filter device which is controlled by the resulting microphone signals, and wherein wanted sound signals are generated in the headphones in response to signals derived from further audio input signals in a second filter device with transfer functions substantially equal to the corresponding transfer functions of the first filter device.

2. Method for reproducing sound signals, according to claim 1, wherein, during initialization, the characteristics of the first and second filter devices are computed by means of a sound source simulation algorithm, which algorithm controls the characteristics such that signals derived from the microphone signals and applied to adjust the filter characteristics are minimized or become substantially zero.

3. Method for reproducing sound signals, according to claim 2, wherein correction signals are applied to the microphone signals, said correction signals being derived from the wanted audio input signals in the second filter device.

4. Method for reproducing sound signals, according to anyone of the preceding claims, wherein the audio input signals of the second filter device have the function of wanted input signals for sound reproducing and of masking signals for the microphone signal as well.

5. Method for reproducing sound signals, according to anyone of the preceding claims, wherein, when a person wearing the headphones wants to listen for some time to the real sound signals of the loudspeakers, the audio input signals of the second filter device are made substantially equal to the audio input signals of the external sound sources during that time.

6. Method for reproducing sound signals, according to anyone of the claims 1-4, wherein, when a person wearing the headphones wants to listen for some time to real sound signals of the loudspeakers, the headphones are switched off.

7. Sound reproducing system, for applying the method of anyone of the preceding claims, comprising headphones with sound generating means and with microphones, and control means, the control means being provided with a first and a second filter device to control the sound signals generated by said sound generating means to simulate in anti-phase at least one external sound source in response to the same unwanted audio input signal as applied to said at least one external sound source and to simulate said at least one external sound source in response to an audio input signal resulting in the wanted sound signals respectively, with regulation means to regulate said first and second filter device such that the signals supplied by the microphones and fed to the control means are minimized or substantially zero.

8. Sound reproducing system according to claim 7, characterized in that the first and second filter device are substantially the same.

9. Sound reproducing system according to claim 8, characterized in that the first and second filter device are realized by one and the same filter device.

10. Sound reproducing system according to claim 7, 8 or 9, characterized in that the control means further comprise combination means and correction means to correct the microphone signals with a correction signal derived from said wanted audio input signals, the transfer function of the correction means being substantially the same as the transfer function of the sound generating means to the microphones.

11. Sound reproducing system, according to anyone of the claims 7-10, characterized in that, when there are more audio input channels for audio input signals of the second filter device than there are external sound sources or audio input channels for input signals of the first filter device, some of the filters of the filter devices may be present in the form of fixed tables stored in a memory in said filters.

12. Algorithm for processing the filter device in anyone of the claims 7-11 and applied in the method of anyone of the claims 1-6.

13. Audio apparatus, provided with the sound reproducing system according to anyone of the claims 7-11.

14. Computer program capable of running on signal processing means in an audio apparatus or cooperating with an audio apparatus comprising the sound reproducing system according to anyone of the claims 7-11.

15. Information carrier, carrying instructions to be executed by signal processing means, the instructions being such as to enable said signal processing means to perform the method according to anyone of the claims 1-6.
